(19) United States
(12) Patent Application Publication
(10) Pub. No.: US 2003/0097656 A1
(43) Pub. Date: May 22, 2003

(54) Broadcasting receiver

(76) Inventor: Akinori Tsubouchi, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/294,634

(22) Filed: Nov. 15, 2002

(30) Foreign Application Priority Data
Nov. 16, 2001 (JP) 351307/2001

(51) Int. Cl. H04N 5/445; G06F 3/00; G06F 13/00; H04N 9/74; H04N 9/76; H04N 9/67

(52) U.S. Cl. 725/38; 348/660; 348/586; 348/599

(57) ABSTRACT

A broadcasting receiver comprises a digital tuner and an analog tuner. An OSD circuit and an adder add video data such as characters produced in the receiver to received video data on a channel tuned in to by the digital tuner. A video analog-to-digital processor converts a received video signal on a channel tuned in to by the analog tuner into digital received video data, and the OSD circuit and the adder similarly add the video data such as characters produced in the receiver to the received video data.

### BACKGROUND OF THE INVENTION

Field of the Invention

The present invention relates to a broadcasting receiver capable of receiving both digital broadcasting and analog broadcasting.

A broadcasting receiver that receives digital broadcasting using a satellite or a terrestrial wave selects any of a plurality of broadcasting waves received through a dedicated antenna or a terrestrial wave antenna using a digital tuner, selects any of a plurality of channels (a transport stream) included in the selected broadcasting wave by demultiplexing processing, extracts a digital signal on the selected channel, and decodes the extracted digital signal, to output a video/audio signal.

A digital and analog broadcasting receiver comprising an analog tuner for receiving conventional analog broadcasting, together with such a digital tuner for receiving digital television broadcasting can be configured.

FIG. 2 is a block diagram showing the schematic configuration of a conventional digital and analog broadcasting receiver. A digital tuner 2 outputs a transport stream on a selected channel, a demultiplexer (DEMUX) 3 produces a video stream, an audio stream, etc., an AV decoder 4 produces video data and audio data, and processing circuits 5 and 6 output an analog video signal and an analog audio signal. Further, an analog tuner 17 performs processing such as channel selection processing for selecting a signal having a frequency corresponding to the selected channel and processing for demodulating the selected signal. The demodulated signal passes through a video processing circuit 28, whereby a video signal (a composite signal, a Y/C signal, a component signal, etc. ) is outputted. Although in FIG. 2, output lines of the video processing circuit 28 are indicated by one line, a video signal is outputted for each video output form, and there are provided selectors 19B, described later, corresponding to the number of video output forms

The output of video based on analog broadcasting and the output of video based on digital broadcasting are switched in an analog signal state by the selector 19B, and the output of audio based on analog broadcasting and the output of audio based on digital broadcasting are switched in an analog signal state by a selector 25.

The conventional broadcasting receiver comprises an OSD (On Screen Display) circuit 12 for video in digital broadcasting and an OSD circuit 26 for video in analog broadcasting. The OSD circuit 12 outputs to an adder 16 bit map data based on character information which it is instructed to output from a main CPU 13. The adder 16 performs processing for superimposing the bit map data on the video data outputted from the AV decoder 4. On the other hand, the OSD circuit 26 for video in analog broadcasting outputs to an OSD addition circuit (a superimposer) 27 bit map data based on character information which it is instructed to output from a sub CPU 15. The OSD addition circuit 27 changes the above-mentioned bit map data into a video signal in correspondence with the composite signal, the Y/C signal, the component signal, or the like which is the video signal outputted from the video processing circuit 28, and superimposes the video signal on a received video signal in analog broadcasting.

In the above-mentioned conventional broadcasting receiver, OSD processing for a digital broadcasting receiving system can be performed in a digital manner, thereby making it possible to perform complicated OSD processing. In OSD processing for an analog broadcasting receiving system, however, video such as characters is added in an analog manner to each of the video signal forms such as the composite signal, the Y/C signal, and the component signal. Accordingly, the OSD quality varies depending on the signal form, and it is difficult to perform complicated OSD processing. Further, the font and the gradation of the characters, for example, are determined by the OSD addition circuit 27. Particularly, processing for superimposing colored characters on received video cannot be satisfactorily performed. Therefore, there is such discontent that the OSD quality on the side of analog broadcasting is inferior to the OSD quality on the side of digital broadcasting

### SUMMARY OF THE INVENTION

In view of the foregoing circumstances, an object of the present invention is to provide a broadcasting receiver capable of enhancing the OSD quality for received video in analog broadcasting.

In order to solve the above-mentioned problem, a broadcasting receiver according to the present invention is characterized by comprising an analog broadcasting receiver for receiving an analog broadcasting wave; a digital broadcasting receiver for receiving a digital broadcasting wave; an on screen display functional unit for superimposing produced video data for adding on received video data or feeding the video data for adding in place of the received video data; means for digitizing an analog receiving signal in the received analog broadcasting and converting the digitized signal into first received video data; means for processing received digital broadcasting to produce second received video data; selection means for selecting either one of the first received video data and the second received video data and feeding the selected data as received video data to the on screen display functional unit; and control means for issuing a switching command to the selection means.

In the above-mentioned configuration, on screen display (OSD) processing at the time of receiving the analog broadcasting can be also performed in a digital manner. Even in the OSD processing at the time of receiving the analog broadcasting, therefore, complicated OSD processing can be performed. Further, the OSD quality does not differ depending on the analog video output form, thereby making it possible to enhance the OSD quality for received video in the analog broadcasting.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a broadcasting receiver 30 in the present embodiment capable of viewing both terrestrial wave digital broadcasting and terrestrial wave analog broadcasting; and

FIG. 2 is a block diagram showing a conventional broadcasting receiver.

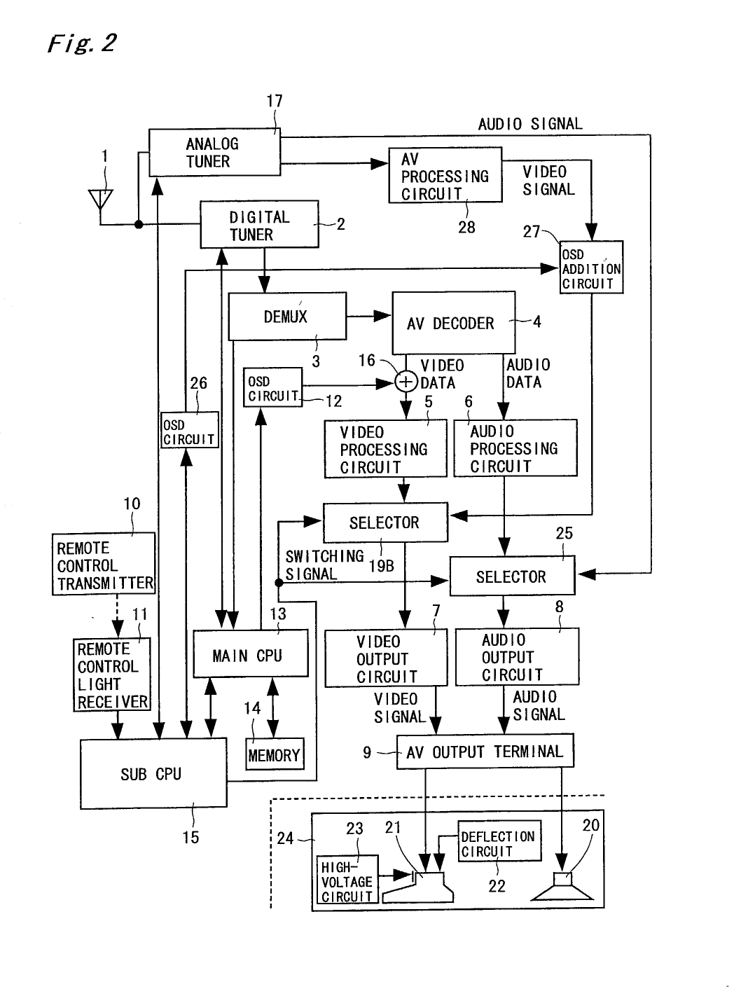

### DESCRIPTION OF THE PREFERRED EMBODIMENTS

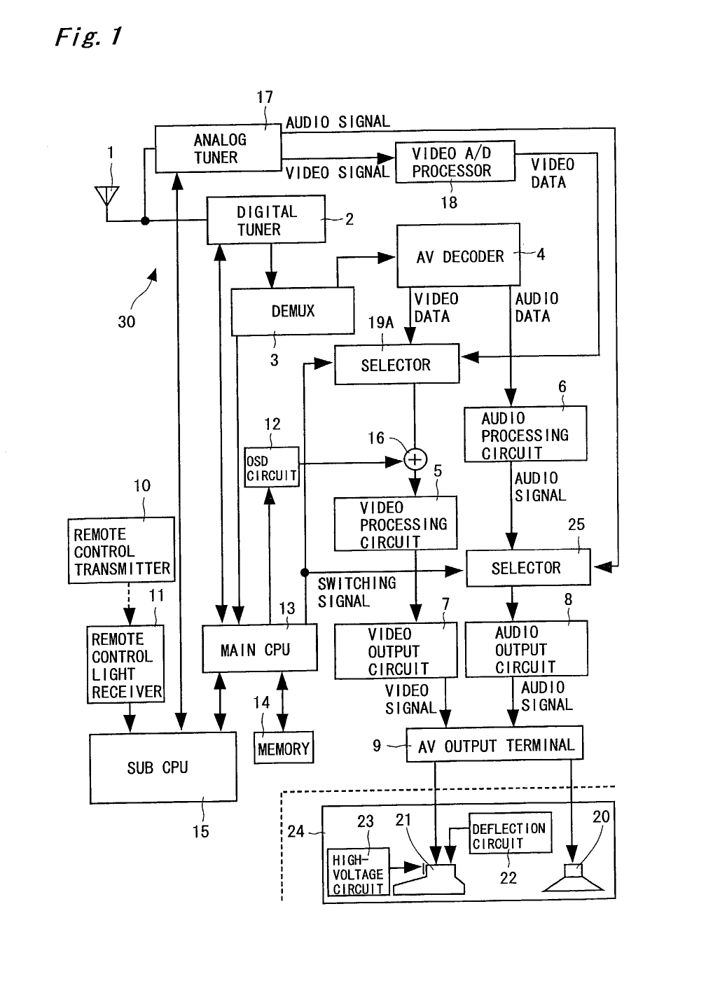

An embodiment of the present invention will be described on the basis of FIG. 1. Herein, a case where a user views terrestrial wave broadcasting is illustrated. For convenience of illustration, the same constituent elements as those in the conventional configuration are assigned the same reference numerals.

An antenna 1 is arranged in a predetermined direction outdoors, and receives a terrestrial broadcasting wave sent from a terrestrial wave broadcasting station.

A digital tuner (for ATSC (Advanced TV System Committee) in the present embodiment) 2 extracts, out of high-frequency digital modulation signals including video/audio data, the signal having a particular frequency. Further, the digital tuner 2 comprises an inverse interleave circuit, an error correcting circuit, and so forth, thereby demodulating the selected digital modulation signal and outputting a transport stream.

A demultiplexer (DEMUX) 3 separates and decodes the above-mentioned transport stream into a video stream and an audio stream based on MPEG2 (Moving Picture Experts Group2) and PSI/SI (Program Specific Information/Service Information). The demultiplexer 3 feeds the video stream and the audio stream to an AV decoder 4, and feeds to a main CPU 13 service information (the name of a program, the details of the program, the time when the program begins, a time period during which the program is continued, etc.) included in the PSI/SI As described above, a plurality of channels are multiplexed on the transport stream. Processing for selecting any of the channels can be performed by extracting from the PSI/SI data indicating which packet ID in the transport stream is used to multiplex the arbitrary channel. The transport stream can be selected on the basis of information related to the PSI/SI.

The AV decoder 4 comprises a video decoder for decoding the video stream and an audio decoder for decoding the audio stream. The video decoder decodes an inputted variable length code to find a quantization factor and a motion vector, thereby carrying out inverse DCT (Discrete Cosine Transformation), motion compensation control based on the motion vector, and the like. The audio decoder decodes an inputted coded signal, to produce audio data. The video data produced by the decoding is outputted to a video processing circuit 5 through a selector 19A, and the audio data is outputted to an audio processing circuit 6.

The video processing circuit 5 receives the video data and subjects the received video data to digital-to-analog (D/A) conversion, to generate a video signal (a composite signal, a Y/C signal, a component signal, etc.) and feed the video signal to a video output circuit 7. The audio processing circuit 6 receives the audio data outputted from the AV decoder 4 and subjects the received audio data to digital-to-analog (D/A) conversion, to generate an analog audio signal.

The selector 19A selects either one of the video data based on digital broadcasting outputted from the AV decoder 4 and the video data based on analog broadcasting outputted from an NTSC (National Television System Standard Committee) decoder 18 and feeds the selected data to the video processing circuit 5. On the other hand, a selector 25 is for an analog signal, and selects either one of the analog audio signal outputted from the audio processing circuit 6 and an analog audio signal outputted from an analog tuner 17 and feeds the selected signal to an audio output circuit 8.

Each of the video output circuit 7 and the audio output circuit 8 comprises an output resistor, an amplifier, and so forth. An AV output terminal 9 is provided with an output unit (a set of a right and left audio output terminal and a video output terminal). A monitor 24 connected to the AV output terminal 9 comprises an image output unit, comprising a deflection circuit 22 and a high-voltage circuit 23, for driving a CRT 21, a speaker 20, and so forth.

The analog tuner (for NTSC in the present embodiment) 17 performs channel selection processing for selecting a signal having a frequency corresponding to a channel selected by the user, processing for demodulating the selected signal, etc., to generate an analog video signal and an analog audio signal.

The video analog-to-digital processor (NTSC decoder) 18 comprises an A/D conversion circuit, and so forth, and digitizes the analog video signal received from the analog tuner 17, produces video data in the same form as that of the video data outputted from the AV decoder 4, and feeds the produced video data to the selector 19A.

An OSD (On-Screen Display) circuit 12 outputs to an adder 16 bit map data based on character information which it is instructed to output from the main CPU 13. The adder 16 performs processing for incorporating the bit map data into the video data outputted from the selector 19A. By the OSD circuit 12, display of a menu screen, an operation guide screen, etc. can be also performed in addition to realizing display of an EPG (Electronic Program Guide) screen based on the service information received by the main CPU 13.

The main CPU 13 carries out control for a channel selection command to the digital tuner 2, an existent channel search, etc., control for writing/reading of existent channel information and OSD display data to/from a memory (EEPROM, etc.) 14, control for the demultiplexer 3, and control for the AV decoder 4, control for the OSD circuit 12, command to switch the selectors 19A and 25, and communication between the main CPU 13 and a sub CPU 15, described later, for example.

A remote control transmitter 10 is a transmitter for sending out a command to a broadcasting receiver 30. When a key (not shown) provided in the remote control transmitter 10 is operated, signal light (a remote control signal) meaning a command corresponding to the key is sent out from a light emitter (not shown). A remote control light receiver 11 receives the signal light, converts the received signal light into an electric signal, and feeds the electric signal to the sub CPU 15.

The sub CPU 15 performs processing for inputting a remote control signal by the remote control transmitter 10 and a signal by a key operation of an operation unit (not shown) to notify the main CPU 13 of information and control for the analog tuner 17.

In the above-mentioned configuration, when the digital broadcasting is received, the received video data outputted from the AV decoder 4 is fed to the video processing circuit 5 through the selector 19A. When the user operates the remote control transmitter 10 to issue a command to display the EPG screen, for example, to the receiver 30, video data for adding produced in the OSD circuit 12 is superimposed on the received video data or is fed to the video processing circuit 5 in place of the received video data by the adder 16. On the other hand, when the analog broadcasting is received, the received video data based on the analog broadcasting outputted from the video A/D processor 18 is fed to the video processing circuit 5 through the selector 19A. When the user operates the remote control transmitter 10 to issue a command to display the menu screen, for example, to the receiver 30, the video data for adding produced in the OSD circuit 12 is superimposed on the received video data based on the analog broadcasting or is fed to the video processing circuit 5 in place of the received video data by the adder 16.

A system for subjecting the received video data in the digital broadcasting to OSD processing in a digital manner is also used for the digitized received video data based on the analog broadcasting. Accordingly, the received video data based on the analog broadcasting is similarly subjected to OSD processing in a digital manner. Even in the OSD processing for the received video based on the analog broadcasting, therefore, complicated OSD processing can be performed. Further, there is no difference in the OSD quality depending on the analog video output form, thereby making it possible to enhance the OSD quality for the received video in the analog broadcasting.

Although description was made of the configuration in which the terrestrial wave broadcasting is received, the present invention is not limited to the same. For example, the present invention is also applicable to a configuration in which both analog broadcasting and digital broadcasting are received by a

As described in the foregoing, according to the present invention, the OSD processing for the received video in the analog broadcasting can be also performed in a digital manner. Even in the OSD processing for the received video in the analog broadcasting, therefore, complicated OSD processing can be performed, thereby making it possible to enhance the OSD quality for the received video in the analog broadcasting.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcasting receiver comprising:
an analog broadcasting receiver for receiving an analog broadcasting wave;
a digital broadcasting receiver for receiving a digital broadcasting wave;
an on screen display functional unit for superimposing produced video data for adding on received video data or feeding the video data for adding in place of the received video data;
means for digitizing an analog receiving signal in the received analog broadcasting and converting the digitized signal into first received video data;
means for processing received digital broadcasting to produce second received video data;
selection means for selecting either one of the first received video data and the second received video data and feeding the selected data as received video data to said on screen display functional unit; and
control means for issuing a switching command to said selection means.
